(19) United States
(12) Patent Application Publication
(10) Pub. No.: US 2024/0412925 A1
(43) Pub. Date: Dec. 12, 2024

(54) SOLID ELECTROLYTIC CAPACITOR ELEMENT AND MANUFACTURING METHOD THEREOF, AND SOLID ELECTROLYTIC CAPACITOR

(71) Applicant: Panasonic Intellectual Property Management Co., Ltd., Osaka (JP)

(72) Inventor: Daisuke USA, OSAKA FU (JP)

(21) Appl. No.: 18/810,121

(22) Filed: Aug. 20, 2024

Related U.S. Application Data
(63) Continuation of application No. PCT/JP2023/005888, filed on Feb. 20, 2023.

(30) Foreign Application Priority Data
Feb. 25, 2022 (JP) 2022-028048

(51) Int. Cl. H01G 9/025; H01G 9/00; H01G 9/15

(52) U.S. Cl. CPC H01G 9/025; H01G 9/0036; H01G 9/15

(57) ABSTRACT

A solid electrolytic capacitor element includes an anode foil having a porous part at a surface layer, a first portion including a first end and a second portion including a second end opposite the first end, a dielectric layer formed on the surface of the porous part, and a solid electrolyte layer covering at least a portion of the dielectric layer. The solid electrolytic capacitor element has an insulating region containing a cured product of a resin composition between the first and second end of the anode foil. In the insulating region, pores of the porous part are filled with the cured product. The resin composition contains an insulating resin material and an additive that modifies the insulating resin material. The content rate of the additive in the resin composition is 3% by mass or more. The glass transition point of the cured product is 230° C. or more.

### CROSS REFERENCE TO RELATED APPLICATION

The present application is a continuing application of International Application No. PCT/JP2023/005888 filed on Feb. 20, 2023, and claims the benefit of priority to Japanese Patent Application No. 2022-028048 filed on Feb. 25, 2022 in the Japan Patent Office. The entire contents of these applications are incorporated herein by reference.

### TECHNICAL FIELD

The present disclosure relates to a solid electrolytic capacitor element, a solid electrolytic capacitor, and a manufacturing method of a solid electrolytic capacitor element.

### BACKGROUND

The solid electrolytic capacitor includes a solid electrolytic capacitor element and an exterior body that seals the solid electrolytic capacitor element, for example. The solid electrolytic capacitor element includes an anode foil, a dielectric layer formed on the surface of the anode foil, and a cathode part that includes a solid electrolyte layer covering at least a portion of the dielectric layer, for example. From the viewpoint of ensuring high capacity, a porous part with a large number of pores is formed at a surface layer of the anode foil. The anode foil may be divided into a first portion that includes a first end and a second portion that includes a second end opposite the first end, and an insulating region may be provided at a predetermined position between the first end and the second end. The insulating region can ensure insulation between the first portion and the cathode part when the cathode part is formed in the second portion of the anode foil via the dielectric layer. The insulating region is formed by attaching an insulating sheet to the surface of the dielectric layer or filling the pores of the porous part with an insulating material, for example.

Patent Literature 1 (WO 2007/061005) proposes a solid electrolytic capacitor that has a shielding layer in a region separating an anode part region and a cathode part region of a substrate for solid electrolytic capacitors that has a porous layer on the surface thereof. In the solid electrolytic capacitor, the shielding layer is formed from a solution or dispersion liquid of a heat-resistant resin or a precursor thereof in which the content of a shielding layer modifying additive (excluding a silane coupling agent) is 0 to 0.1% by mass (based on the mass of the heat-resistant resin or precursor thereof).

Patent Literature 2 (WO 2008/038584) proposes a solid electrolytic capacitor that has shielding layers formed by laminating a plurality of layers in a region separating an anode part region and a cathode part region of a substrate for solid electrolytic capacitors that has a porous layer on the surface thereof. In the solid electrolytic capacitor, a first shielding layer formed by laminating directly onto the substrate for solid electrolytic capacitors, among the laminated shielding layers formed by lamination, is made of a solution or dispersion liquid of a heat-resistance resin or a precursor thereof, which does not contain a shielding layer modifying additive (excluding a silane coupling agent) or in which the content of the shielding layer modifying additive is 0.1% by mass or less (based on the mass of the heat-resistant resin or precursor thereof).

### SUMMARY

When forming an insulating region by filling the pores of a porous part with an insulating resin material (resin composition, etc.) and curing the resin material, it is difficult to highly fill the small pores with the resin material. If the filling rate of the resin material in the pores of the porous part is low, a conductive material such as a conductive polymer constituting the solid electrolyte layer may penetrate into the pores of the insulating region or may penetrate into the first portion through the pores, for example, when forming the solid electrolyte layer in the second portion. This makes it difficult to ensure insulation between the cathode part including the solid electrolyte layer and the first portion, leading to an increase in leakage current.

A first aspect of the present disclosure relates to a solid electrolytic capacitor element including:
an anode foil having a porous part at a surface layer, and having a first portion including a first end and a second portion including a second end opposite the first end;
a dielectric layer formed on a surface of the porous part; and
a solid electrolyte layer covering at least a portion of the dielectric layer,
wherein the solid electrolytic capacitor element has, between the first end and second end of the anode foil, an insulating region containing a cured product of a resin composition,
in the insulating region, pores of the porous part are filled with the cured product,
the resin composition contains an insulating resin material and an additive that modifies the insulating resin material,
a content rate of the additive in the resin composition is 3% by mass or more, and
a glass transition point of the cured product is 230° C. or more.

A second aspect of the present disclosure relates to a solid electrolytic capacitor including at least one of the solid electrolytic capacitor element described above.

A third aspect of the present disclosure relates to a manufacturing method of a solid electrolytic capacitor element, including:
a first step of preparing an anode foil having a porous part at a surface layer, and having a first portion including a first end and a second portion including a second end opposite the first end;
a second step of forming a dielectric layer on a surface of the porous part;
a third step of forming, between the first end and second end of the anode foil, an insulating region containing a cured product of a resin composition; and
a fourth step of forming a solid electrolyte layer covering at least a portion of the dielectric layer,
wherein the resin composition contains an insulating resin material and an additive that modifies the insulating resin material, a content rate of the additive in the resin composition is 3% by mass or more, and a glass transition point of the cured product is 230° C. or more, and
the third step includes a sub-step of filling pores of the porous part with a treatment liquid containing the resin composition and a solvent, and curing the resin composition.

According to the present disclosure, it is possible to keep leakage current low in a solid electrolytic capacitor that has an insulating region containing a cured product of an insulating resin material.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a schematic cross-sectional view of a solid electrolytic capacitor according to a first embodiment of the present disclosure.

FIG. 2 is a schematic cross-sectional view of a solid electrolytic capacitor element included in the solid electrolytic capacitor illustrated in FIG. 1.

### DETAILED DESCRIPTION

When forming the insulating region, many voids may be left in the insulating region due to the pores of the porous part formed at the surface layer of the anode foil not being highly filled with a resin composition, which is the material of the insulating region. In this state, a conductive material such as a conductive polymer may penetrate into the voids of the insulating region, when forming the solid electrolyte layer. In addition, the conductive material may also penetrate into the first portion (anode part) through the voids of the insulating region. In these cases, the anode part and the cathode part including the solid electrolyte layer are electrically connected through the conductive material that has penetrated in the voids of the insulating region or the voids of the anode part, leading to an increase in leakage current. The solid electrolyte layer is formed by in situ polymerization such as chemical polymerization or electrolytic polymerization, or by using a liquid composition containing a conductive polymer (conjugated polymer and dopant, etc.), for example. In particular, when forming the solid electrolyte layer by in situ polymerization, the polymerization liquid contains components with relatively low molecular weights (precursor of conjugated polymer, dopant, and oxidizing agent, etc.). Thus, the polymerization liquid is likely to penetrate into the pores and the above-mentioned voids. In addition, when forming a solid electrolyte layer by electrolytic polymerization, a conductive material may be precoated prior to the electrolytic polymerization. The liquid dispersion (liquid composition) containing the conductive material used for precoating has a relatively low concentration and low viscosity, and is also likely to penetrate into the insulating region and the voids of the anode part. Thus, in order to reduce penetration of these conductive materials, it is important to highly fill the pores of the porous part with the resin composition (or a cured product thereof) when forming the insulating region.

In order to highly fill the pores of the porous part, it is important that the concentration of the dry solid content in the treatment liquid containing the resin composition for forming the insulating region is high. However, as the concentration of the dry solid content in the treatment liquid increases, the viscosity tends to increase. In particular, when the glass transition point (Tg) of the cured product is high, the viscosity tends to increase markedly. When the viscosity of the treatment liquid is high, the ability to fill the pores of the porous part deteriorates. If a solvent is used to lower the viscosity of the treatment liquid, the concentration of the dry solid content in the treatment liquid decreases. Since the pores of the porous part are fine, even if a treatment liquid with a low concentration of dry solid content is repeatedly applied to the porous part, the openings of the pores are easily clogged at an early stage, making it difficult to fill the pores to the bottom. Thus, even in this case, it is difficult to enhance the ability to fill the pores with the resin composition.

In view of the above, the present disclosure is exemplified below.

### Technique (1)

A solid electrolytic capacitor element of the present disclosure includes an anode foil having a porous part at a surface layer and having a first portion including a first end and a second portion including a second end opposite the first end, a dielectric layer formed on a surface of the porous part, and a solid electrolyte layer covering at least a portion of the dielectric layer. The solid electrolytic capacitor element has an insulating region containing a cured product of a resin composition between the first end and second end of the anode foil. In the insulating region, pores of the porous part are filled with the cured product. The resin composition contains an insulating resin material and an additive that modifies the insulating resin material. The content rate of the additive in the resin composition is 3% by mass or more. The glass transition point of the cured product is 230° C. or more.

As described above, in the solid electrolytic capacitor element of the present disclosure, the insulating region is formed using the resin composition that contains the insulating resin material and the additive that modifies the insulating resin material. The insulating region includes the cured product of the resin composition. The content rate of the additive in the resin composition is 3% by mass or more, and the Tg of the cured product is 230° C. or more. In the solid electrolytic capacitor element, the insulating region is in a state where the pores of the porous part are filled with the cured product of the resin composition. When the Tg of the cured product is in a high range of 230° C. or more, the viscosity of the treatment liquid containing the resin composition for forming the insulating region tends to increase. However, using 3% by mass or more of the additive that modifies the insulating resin material makes it possible to keep the viscosity low while maintaining a high concentration of dry solid content in the treatment liquid, and to enhance the ability to fill the pores of the porous part with the resin composition. In the insulating region, the pores of the porous part are highly filled with the insulating cured product, and thus penetration of the conductive material into the voids of the insulating region is inhibited when forming the solid electrolyte layer. Therefore, the insulation between the first portion (anode part) and the cathode part including the solid electrolyte layer can be more reliably ensured. This makes it possible to reduce leakage current. In addition, in the present disclosure, it is possible to ensure a high initial capacitance and to keep the initial tan δ and equivalent series resistance (ESR) low, and also ensure excellent capacitor performance.

### Technique (2)

In technique (1), the viscosity at 25° C. of a y-butyrolactone solution containing the resin composition at a concentration of 30% by mass may be 1,000 mPa·s or more and 10,000 mPa·s or less.

### Technique (3)

In technique (1) or technique (2), the content rate of the additive in the resin composition may be 60% by mass or less.

### Technique (4)

In any one of techniques (1) to (3), the additive may interact or react with the insulating resin material.

### Technique (5)

In any one of techniques (1) to (4), the additive may contain a polymer of an epoxy compound.

### Technique (6)

In any one of techniques (1) to (5), the insulating resin material may include a polyimide resin.

### Technique (7)

In any one of techniques (1) to (6), in a cross section of the solid electrolytic capacitor element in the insulating region, the proportion of an area of the cured product filling the pores to a total area of the pores may be 80% or more.

### Technique (8)

With regard to any one of techniques (1) to (7), in the insulating region, the cured product may be further formed on a main surface of the anode foil via the dielectric layer. On the main surface of the anode foil, the cured product formed on the dielectric layer on one main surface side of the anode foil has a maximum thickness of t_{c}, and the anode foil has a thickness of t_{f}. In this case, the ratio of the maximum thickness t, of the cured product to the thickness t_{f} of the anode foil (=t_{c}/t_{f}) may be 0.12 or less.

The present disclosure also includes Technique (9).

### Technique (9)

A solid electrolytic capacitor including at least one of the solid electrolytic capacitor element described above.

### Technique (10)

In technique (9), the solid electrolytic capacitor may include an exterior body that seals the solid electrolytic capacitor element.

The present disclosure also includes a manufacturing method of a solid electrolytic capacitor element. For example, the solid electrolytic capacitor element can be formed by a manufacturing method including:
a first step of preparing an anode foil having a porous part at a surface layer, and having a first portion including a first end and a second portion including a second end opposite the first end;
a second step of forming a dielectric layer on a surface of the porous part;
a third step of forming, between the first end and second end of the anode foil, an insulating region containing a cured product of a resin composition; and
a fourth step of forming a solid electrolyte layer covering at least a portion of the dielectric layer.

More specifically, the present disclosure includes Technique (11).

### Technique (11)

A manufacturing method of a solid electrolytic capacitor element of the present disclosure includes:
a first step of preparing an anode foil having a porous part at a surface layer, and having a first portion including a first end and a second portion including a second end opposite the first end;
a second step of forming a dielectric layer on a surface of the porous part;
a third step of forming, between the first end and second end of the anode foil, an insulating region containing a cured product of a resin composition; and
a fourth step of forming a solid electrolyte layer covering at least a portion of the dielectric layer.

The resin composition contains an insulating resin material and an additive that modifies the insulating resin material. The content rate of the additive in the resin composition is 3% by mass or more. The glass transition point of the cured product is 230° C. or more.

The third step includes a sub-step of filling the pores of the porous part with a treatment liquid containing the resin composition and a solvent, and curing the resin composition.

### Technique (12)

In the above-described manufacturing method of a solid electrolytic capacitor element or technique (11), the content rate of a dry solid content in the treatment liquid may be 30% by mass or more, and the viscosity of the treatment liquid at 25° C. may be 1,000 mPa·s or more and 50,000 mPa·s or less.

### Technique (13)

In technique (11) or technique (12), the fourth step may include a second sub-step of forming at least a portion of the solid electrolyte layer by in situ polymerization of a precursor of a conjugated polymer in the presence of a dopant.

### Technique (14)

In technique (13), the fourth step may include a first sub-step of precoating the surface of the dielectric layer with a liquid composition containing a conductive material, prior to the second sub-step.

Note that the concentration of the dry solid content in the treatment liquid or the content ratio of the dry solid content in the treatment liquid is the total content rate of components other than the solvent to the mass of the treatment liquid.

The solid electrolytic capacitor element, the solid electrolytic capacitor, and the manufacturing method of the solid electrolytic capacitor element of the present disclosure, including techniques (1) to (14), will be described in more detail below with reference to the drawings as necessary. At least one of techniques (1) to (14) may be combined with at least one of the elements described below, as long as there is no technical contradiction. Note that the drawings are schematic, and the ratio of dimensions (e.g., thickness) of each component may differ from the actual ratio.

### Solid Electrolytic Capacitor

The solid electrolytic capacitor element included in the solid electrolytic capacitor includes an anode body (such as an anode foil), a dielectric layer formed on the surface of the anode body, and a cathode part that covers at least a portion of the dielectric layer. The cathode part includes a solid electrolyte layer that covers at least a portion of the dielectric layer. Hereinafter, the solid electrolytic capacitor element will also be simply called a capacitor element.

### Capacitor Element

### Anode Foil

The anode foil may contain a valve metal, an alloy containing a valve metal, a compound containing a valve metal, or the like. The anode foil may contain one of these materials or two or more thereof in combination. The valve metal is preferably aluminum, tantalum, niobium, or titanium, for example.

The anode foil has a porous part at least at the surface layer. The anode foil has a large number of fine pores in the porous part. With such a porous part, the anode body has fine roughness at least on the surface. The anode foil having the porous part at the surface layer can be obtained by roughening the surface of a base material (metal foil, etc.) containing a valve metal, for example. The roughening may be performed by an etching process (electrolytic etching, chemical etching, etc.), for example. Such an anode foil has a base part (core part) and a porous part integrally formed with the core part on both surfaces of the core part, for example.

The anode foil is divided into a second portion where a cathode part is formed via a dielectric layer, and a first portion other than the second portion. The second portion will be called a cathode forming part, and the first portion will also be called an anode extraction part (or anode part). The anode foil has a first end and a second end opposite the first end. The first end and the second end correspond to both ends of the anode foil in the length direction. The first portion includes the first end, and the second portion includes the second end. An insulating region is formed between the first end and the second end. Note that the length direction of the anode foil is a direction that connects the center of the end face of the first end and the center of the end face of the second end when the anode foil is stretched (not bent).

The porous part may be formed in the second portion and a part that forms the insulating region or may be formed at the entirety of both surfaces of the anode foil (specifically, the second portion and the first portion). The first portion is used for electrical connection with an external electrode on the anode side. For example, one end of an anode lead is electrically connected to the first portion, and the other end of the anode lead is extracted from the exterior body and electrically connected to the external electrode.

The thickness (t_{f}) of the anode foil may be 50 μm or more and 200 μm or less or may be 70 μm or more and 150 μm or less. The thickness t_{f} of the anode foil is determined by measuring the thickness of the anode foil at a plurality of points (e.g., five points) using a sample for determining the filling rate of the cured product described later, and averaging the measurement values.

### Dielectric Layer

The dielectric layer is formed so as to cover the surface of at least a portion of the anode foil, for example. The dielectric layer is an insulating layer that functions as a dielectric. The dielectric layer is formed by anodizing the valve metal on the surface of the anode foil through chemical conversion treatment or the like. Since the dielectric layer is formed on the surface of the porous part of the anode foil, the surface of the dielectric layer has fine roughness corresponding to the shape of the porous part of the anode foil.

The dielectric layer contains an oxide of a valve metal. For example, when tantalum is used as the valve metal, the dielectric layer contains Ta₂O₅, and when aluminum is used as the valve metal, the dielectric layer contains Al₂O₃. The dielectric layer is not limited to these examples, and need only function as a dielectric.

### Insulating Region

The insulating region is provided at a predetermined width in the porous part formed between the first end and second end of the anode foil. The insulating region may be formed at the end of the first portion on the second portion side, for example. The cathode part may, however, be formed at the end of the surface of the insulating region on the second end side. In other words, the insulating region may be provided so as to range from the end of the first portion on the second portion side to the end of the second portion on the first portion side. From the viewpoint of more reliably ensuring the insulation between the first portion and the cathode part, it is preferable that the insulating region is not provided in the second portion.

The insulating region contains a cured product of the resin composition. In the insulating region, the pores of the porous part are filled with the cured product. The Tg of the cured product is 230° C. or more and may be 250° C. or more. When the Tg of the cured product is this high, the viscosity of the treatment liquid containing the resin composition for forming the insulating region is likely to increase, and the ability to fill the pores of the porous part with the resin composition tends to decrease. In addition, even if the treatment liquid is diluted with a solvent, the amount of the dry solid content of the treatment liquid is reduced, and thus the ability to fill the pores with the resin composition is likely to decrease. In the present disclosure, the resin composition contains an insulating resin material and an additive (hereinafter, also called first additive) that modifies the insulating resin material, and the content of the additive in the resin composition is 3% by mass or more. Thus, even though the Tg of the cured product of the resin composition is high as described above and the viscosity of the treatment liquid containing the resin composition tends to increase, the pores can be highly filled with the resin composition (or a cured product thereof). Therefore, the insulating region makes it easier to ensure insulation between the cathode part and the first portion (anode part), thereby reducing leakage current.

The content of the first additive in the resin composition is 3% by mass or more, and may be 5% by mass or more, 10% by mass or more, or 13% by mass or more. When the resin composition contains the first additive at such a content rate, it is possible to keep the viscosity of the treatment liquid for forming the insulating region low while maintaining a high amount of dry solid content of the treatment liquid, thereby enhancing the ability to fill the pores with the resin composition (or a cured product thereof). The content rate of the first additive in the resin composition is 60% by mass or less, for example, and may be 55% by mass or less or 50% by mass or less. When the content rate of the first additive is in such a range, it is easy to ensure a high Tg of the cured product. These lower limit values and upper limit values can be combined in any combinations. The content rate of the first additive in the resin composition may be 3% by mass or more (or 5% by mass or more) and 60% by mass or less, 10% by mass or more (or 13% by mass or more) and 60% by mass or less, for example. In these ranges, the upper limit values may be changed to the above values.

The viscosity of the y-butyrolactone solution containing the resin composition at a concentration of 30% by mass at 25° C. may be 10,000 mPa·s or less, may be 8,000 mPa·s or less or may be 6,000 mPa·s or less. Note that the concentration of the resin composition in the solution is the content rate (% by mass) of the dry solid content in the solution. Since the Tg of the cured product is high as described above, the viscosity of the solution containing the resin composition in which the content rate of the dry solid content is high tends to be high. In the present disclosure, however, the first additive is used at a content rate such as described above, and thus the viscosity of the solution can be kept low. From the viewpoint of holding the treatment liquid for forming the insulating region at a predetermined position and easily forming the insulating region, the viscosity of the above solution at 25° C. is 1,000 mPa·s or more, for example, and may be 2,000 mPa·s or more. These upper and lower limits can be combined in any combinations.

The viscosity of the solution can be measured using a cone-plate viscometer at a rotation speed of 60 rpm.

The insulating resin material can be a resin material in which the Tg of the cured product of the resin composition falls within the above range. The insulating resin material may be a curable resin or may be a thermoplastic resin. When using a thermoplastic resin as the insulating resin material, a cured product (or a solidified product) of the resin composition is formed by the reaction between the first additive and the thermoplastic resin, for example. When the insulating resin material is a curable resin, it is preferable that the Tg of the cured product of the curable resin is also high. The Tg of the cured product of the curable resin may be 230° C. or more or may be 250° C. or more.

Examples of the insulating resin materials include curable resins (polyimide resin, silicon resin, phenolic resin, urea resin, melamine resin, unsaturated polyester, furan resin, polyurethane, silicone resin (silicone), curable acrylic resin, epoxy resin, etc.), photoresists, and thermoplastic resins (e.g., polyamide, polyamideimide, thermoplastic polyimide, polyphenylenesulfone resin, polyethersulfone resin, cyanate ester resin, and fluororesin). From the viewpoint of obtaining a high Tg of the cured product and easily ensuring high heat resistance, polyimide resins (especially curable polyimide resins) are preferred. Examples of curable polyimide resins include curable polyamideimide and curable polyimide. The insulating resin material may contain one of these resins or may contain two or more thereof in combination. Note that, in addition to polymerized resins, the insulating resin material includes precursors of resins (monomer, oligomer, prepolymer, etc.) depending on the type of resin. The curable resin may be a one-component curable type or a two-component curable type. The resin composition may contain, in addition to the insulating resin material and the first additive, at least one selected from the group consisting of a curing agent, a curing accelerator, a polymerization initiator, a catalyst, and the like.

The Tg of the cured product of the resin composition is determined by dynamic mechanical analysis (DMA) under conditions of a temperature rise rate of 2° C./min and a frequency of 1 Hz, for example.

The first additive is a component that modifies the insulating resin material. The first additive preferably contains a component that interacts or reacts with the insulating resin material. Examples of the first additive include a silane coupling agent, a surface tension adjuster, an epoxy compound or a polymer thereof, and the like. The first additive is, however, a component different from the insulating resin material. The resin composition may contain one type of first additive or may contain two or more types in combination. It is considered that when the resin composition contains the first additive at as a relatively large content rate as such as 3% by mass or more, the first additive enters the molecular chains of the insulating resin material, and thus the permeability of the resin composition into the pores of the porous part is improved by the fluidity being improved.

Examples of the silane coupling agent include tetraalkoxysilanes (tetramethoxysilane, etc.), alkoxysilanes having a hydrocarbon group (methyltrimethoxysilane, ethyltrimethoxysilane, n-propyltrimethoxysilane, phenyltrimethoxysilane, etc.), alkoxysilanes having a functional group [3-(trimethoxysilyl)propylamine, N-(2-aminoethyl)-3-aminopropyltrimethoxysilane, 3-(trimethoxysilyl)propylmethacrylate, 3-glycidoxypropyltrimethoxysilane, etc.], and the like. The content rate of the silane coupling agent in the resin composition may be low, and the resin composition may not contain a silane coupling agent.

Examples of the surface tension regulator include antifoaming agent, silicon-based surface tension regulator, non-silicon-based surface tension regulators, and the like. Examples of the silicon-based surface tension regulators include silicone oil, silicon-based surfactant, and silicon-based synthetic lubricant. Examples of the non-silicon-based surface tension regulators include lower alcohol, mineral oil, oleic acid, polypropylene glycol, glycerin higher fatty acid esters, higher alcohol borate esters, fluorine-containing surfactant, and the like.

Examples of the epoxy compound include glycidyl ether, glycidyl ester, alicyclic epoxy compound, and the like. Examples of the epoxy compound include bisphenol-type epoxy compounds (bisphenol A-type epoxy compound, bisphenol F-type epoxy compound, etc.), polycyclic aromatic epoxy compounds (naphthalene-type epoxy compound, etc.), novolac-type epoxy compound, and the like. Examples of the polymer of the epoxy compound include reaction products of epoxy compound and active hydrogen-containing compounds (amine, hydroxy compound, phenolic compound, acid anhydride, etc.). The epoxy compound and a polymer thereof are preferably liquid (having fluidity) at 25° C. Such an epoxy compound or a polymer thereof has the effect of reducing the viscosity of the treatment liquid, and is particularly excellent in increasing the ability to fill the pores of the porous part with the cured product, since it reacts with the insulating resin material such as a polyimide resin and is incorporated into the cured product.

The resin composition may contain, in addition to the first additive, a known additive (second additive) used for forming the insulating region of the capacitor element, as necessary. Examples of the second additive include flame retardant, filler, colorant, release agent, and inorganic ion scavenger.

In the present disclosure, in the insulating region, the pores of the porous part can be highly filled with the resin composition (or a cured product thereof) containing the insulating resin material. In a cross section of the solid electrolytic capacitor element in the insulating region (more specifically, a cross section of a part including the insulating region and the anode foil), the proportion of the area of the cured product filling the pores to the total area of the pores (filling rate of the cured product) is 80% or more, for example.

The filling rate of the cured product can be determined using the anode foil with the insulating region before the formation of the solid electrolyte layer (before precoating). More specifically, the anode foil with the insulating region is embedded in a curable resin, and the curable resin is cured. The cured product is subjected to a polishing process or a cross-section polisher process to expose a cross section parallel to the thickness direction of the insulating region and parallel to the length direction of the anode foil. The cross section is a cross section that passes through the center of the width of the insulating region (in other words, the length in the direction parallel to the width direction of the anode foil). In this manner, a measurement sample is obtained. Then, the cross section of the sample is subjected to image processing and divided into a metal part (including a dielectric layer part) constituting the anode foil, a void part, and a part occupied by the cured product. The proportion (%) of the area of the part occupied by the cured product to the total area of the void part and the part occupied by the cured product is determined, and the determined value is defined as the filling rate of the cured product. Each area is measured in an image in which the cross section of the anode foil in the thickness direction including the entire part with the insulating region is observable. In the length direction, the area is determined for a part having a length of 0.5 L from the center of the length L of the insulating region, and in the thickness direction, the area is determined for the entire porous part (if porous parts are formed on both surface layers, both porous parts are applied).

In the insulating region, the cured product may be formed not only in the pores but also on the main surface of the anode foil via the dielectric layer. If necessary, a sheet-like insulating material such as an insulating tape may be attached to the main surface of the anode foil.

When the cured product is formed on the main surface of the anode foil via the dielectric layer, the maximum thickness t, of the cured product formed on the dielectric layer on the main surface of the anode foil may be 20 m or less or may be 15 m or less. When the maximum thickness t, is in such a range, leakage current is further reduced and the short circuit occurrence rate can be kept low. In addition, in stacking the capacitor elements, the stress of folded lead frames can be kept low. The maximum thickness t, may be 0 m or more. The maximum thickness t, is the maximum value of the thickness of the cured product on one main surface side of the anode foil. The thickness of the cured product is measured using the cross-sectional sample for measuring the filling rate described above.

The ratio (=t_{c}/t_{f}) of the maximum thickness t, of the cured product to the thickness t_{f} of the anode foil may be 0.12 or less, may be 0.11 or less or may be 0.10 or less. When the t_{c}/t_{f} ratio is in such a range, leakage current is further reduced and the short circuit occurrence rate can be kept low. The t_{c}/t_{f} ratio may be 0.01 or more.

The insulating region can be formed by a step (third step) that includes a sub-step of filling the pores of the porous part with a treatment liquid containing a resin composition (e.g., components of the resin composition) and a solvent, and curing the resin composition, for example.

The content rate of the dry solid content of the treatment liquid (the concentration of the resin composition) is 30% by mass or more, for example, and may be 30% by mass or more and 50% by mass or less. The viscosity of the treatment liquid at 25° C. may be 1,000 mPa·s or more and 50,000 mPa·s or less, may be 2,000 mPa·s or more and 35,000 mPa·s or less or may be 2,500 mPa·s or more and 30,000 mPa·s or less. In the present disclosure, combining the resin composition having a high Tg of the cured product as described above with the first additive at a specific content rate makes it possible to keep the viscosity of the treatment liquid for forming the insulating region in such a low range even if the content rate of the dry solid content of the treatment liquid is high as described above. Thus, the pores of the porous part can be highly filled with the resin composition (or a cured product thereof), and penetration of conductive material into the voids remaining in the insulating region can be reduced, thereby reducing leakage current. Note that the viscosity of the treatment liquid can be measured using a cone-plate type viscometer at a rotation speed of 60 rpm.

In a manufacturing method of a capacitor element, a first step of preparing an anode foil that has a porous part at a surface layer and has a first portion including a first end and a second portion including a second end opposite the first end, and a second step of forming a dielectric layer on the surface of the porous part are performed prior to a third step of forming an insulating region. For each step, description of the anode foil and the dielectric layer can be referred to.

### Cathode Part

The cathode part is formed so as to cover at least a portion of the dielectric layer formed on the surface of the anode body. The cathode part includes at least a solid electrolyte layer. The cathode part may include a solid electrolyte layer that covers at least a portion of the dielectric layer, and a cathode extraction layer that covers at least a portion of the solid electrolyte layer, for example. Each layer constituting the cathode part can be formed by a known method according to the layer configuration of the cathode part.

Hereinafter, the components of the cathode part will be described.

### Solid Electrolyte Layer

The solid electrolyte layer contains a conductive polymer (conjugated polymer, dopant, etc.), for example. The solid electrolyte layer may contain a manganese compound, an additive, and the like, for example.

Examples of the conjugated polymer include known conjugated polymers used in solid electrolytic capacitors, such as 7r-conjugated polymers. Examples of the conjugated polymer include polymers having a basic skeleton of polypyrrole, polythiophene, polyaniline, polyfuran, polyacetylene, polyphenylene, polyphenylenevinylene, polyacene, and polythiophenevinylene. The polymer need only contain at least one monomer unit constituting the basic skeleton. The monomer unit also includes a monomer unit having a substituent. The above polymer includes a homopolymer and a copolymer of two or more monomers. For example, polythiophene includes poly(3,4-ethylenedioxythiophene) and the like, for example. The solid electrolyte layer may contain one type of conjugated polymer or may contain two or more types in combination.

The dopant may be a polymer anion such as polystyrene sulfonic acid (PSS). Also, the dopant may be a compound capable of generating an anion (e.g., an aromatic sulfonic acid such as naphthalene sulfonic acid or toluene sulfonic acid). However, the dopant is not limited only thereto.

The solid electrolyte layer is formed so as to cover at least a portion of the dielectric layer (fourth step). The solid electrolyte layer is formed after the formation of the insulating region (after the third step) from the viewpoint of ensuring insulation from the first portion.

The solid electrolyte layer may be formed by in situ polymerization (more specifically, polymerization on the dielectric layer) of a precursor of a conjugated polymer (monomer, oligomer, etc.) in the presence of a dopant, for example. The dopant may be an aromatic sulfonic acid. At least one of chemical polymerization and electrolytic polymerization may be used for the in situ polymerization. Alternatively, the solid electrolyte layer may be formed by applying a treatment liquid (solution or dispersion liquid) containing a conductive polymer (conjugated polymer and dopant, etc.) to the dielectric layer and drying the treatment liquid. Examples of the dispersion medium (solvent) include water, an organic solvent, or a mixture thereof. The solid electrolyte layer may be formed by combining a method using in situ polymerization and a method using a treatment liquid containing a conductive polymer. For example, after a portion of the solid electrolyte layer is formed using in situ polymerization, the remaining part of the solid electrolyte layer may be formed using a treatment liquid containing a conductive polymer.

In the electrolytic polymerization, the surface of the dielectric layer may be precoated prior to polymerization. The precoating may be performed using a liquid composition (liquid dispersion, etc.) containing a conductive material, for example. More specifically, the precoating may be performed using a liquid dispersion containing a conductive polymer (conjugated polymer and dopant, etc.). In the liquid dispersion used for precoating, the conductive polymer is small in particle diameter and is low in concentration. For example, the average primary particle diameter of the conductive polymer particles contained in the liquid dispersion for precoating is 100 nm or less.

The polymerization liquid used in the in situ polymerization easily permeates into the fine recesses of the dielectric layer. Thus, the method using the in situ polymerization is suitable for forming a solid electrolyte at least in the fine recesses of the dielectric layer. Therefore, the step of forming a solid electrolyte layer (fourth step) may include a sub-step (second sub-step) of forming at least a portion of the solid electrolyte layer by in situ polymerization of a precursor of a conjugated polymer in the presence of a dopant. In addition, prior to the second sub-step, a sub-step (first sub-step) of precoating the surface of the dielectric layer using a liquid composition containing a conductive material may be performed. The liquid composition for precoating also easily permeates into the fine recesses of the dielectric layer. In the present disclosure, since the ability to fill the cured product of the resin composition in the porous part of the insulating region can be increased. Thus, even when forming at least a portion of the solid electrolyte layer by in situ polymerization or performing precoating, it is possible to effectively inhibit the polymerization liquid or the liquid composition for precoating from penetrating into the voids in the insulating region or the first portion. Therefore, even in such cases, leakage current can be reduced.

### Cathode Extraction Layer

The cathode extraction layer includes at least a first layer that is in contact with the solid electrolyte layer and covers at least a portion of the solid electrolyte layer, and may include the first layer and a second layer that covers the first layer. Examples of the first layer include a layer containing conductive particles and a metal foil. The conductive particles may be at least one selected from conductive carbon and metal powder, for example. The cathode extraction layer may be constituted of a layer containing conductive carbon as the first layer (also referred to as carbon layer) and a layer containing metal powder or a metal foil as the second layer, for example. When a metal foil is used as the first layer, the cathode extraction layer may be constituted of this metal foil.

The conductive carbon may be graphite (artificial graphite, natural graphite, etc.), for example.

The layer containing metal powder as the second layer can be formed by laminating a composition containing metal powder onto the surface of the first layer, for example. The second layer may be a metal paste layer (silver paste layer, etc.) formed using a composition containing metal powder such as silver particles and a resin (binder resin), for example. Although the resin may be a thermoplastic resin, it is preferable to use a thermosetting resin such as an imide resin or an epoxy resin.

When a metal foil is used as the first layer, the type of metal is not particularly limited, but it is preferable to use a valve metal such as aluminum, tantalum, or niobium, or an alloy containing a valve metal. The surface of the metal foil may be roughened as necessary. The surface of the metal foil may be provided with a chemical conversion film or may be provided with a coating film of a metal (dissimilar metal) different from the metal constituting the metal foil or a nonmetal. Examples of the dissimilar metal or nonmetal include metals such as titanium and nonmetals such as carbon (conductive carbon, etc.).

The above-described coating film of the dissimilar metal or non-metal (e.g., conductive carbon) may be the first layer and the above-described metal foil may be the second layer.

The manufacturing method of a capacitor element may further include a step of forming a cathode extraction layer (fifth step).

### Separator

When a metal foil is used for the cathode extraction layer, a separator may be interposed between the metal foil and the anode foil. The separator is not particularly limited and may be a nonwoven fabric containing fibers of cellulose, polyethylene terephthalate, vinylon, or polyamide (e.g., aliphatic polyamide or aromatic polyamide such as aramid), for example.

### Related Matters

The solid electrolytic capacitor includes at least one capacitor element and an exterior body that seals the capacitor element, for example. The solid electrolytic capacitor may include two or more capacitor elements. The solid electrolytic capacitor may be a wound type, and may also be a chip type or a stacked type. For example, the solid electrolytic capacitor may include two or more wound capacitor elements or may include two or more stacked capacitor elements. The configuration of the capacitor element need only be selected according to the type of solid electrolytic capacitor.

In the capacitor element, one end of a cathode lead is electrically connected to the cathode extraction layer. One end of an anode lead is electrically connected to the anode body. The other end of the anode lead and the other end of the cathode lead are extracted from the resin exterior body or the case. The other end of each lead exposed from the resin exterior body or the case is used for solder connection with a substrate on which the solid electrolytic capacitor is to be mounted, or the like. Each lead may be a lead wire or a lead frame.

The solid electrolytic capacitor can be obtained by a manufacturing method including a step of forming a capacitor element and a step of sealing at least one solid electrolytic capacitor element with an exterior body, for example. The capacitor element is formed by the above-described manufacturing method (e.g., a manufacturing method including the first to fifth steps, etc.), for example. For example, in manufacturing a solid electrolytic capacitor including two or more stacked capacitor elements, the manufacturing method further includes a step of stacking the two or more capacitor elements prior to the sealing step. Then, in the sealing step, the two or more stacked capacitor elements are sealed with the exterior body.

The exterior body also includes a case. The exterior body may include a resin. For example, the capacitor element and the material resin of the exterior body (e.g., an uncured thermosetting resin and a filler) may be placed in a mold, and the capacitor element may be sealed with the resin exterior body by transfer molding, compression molding, or the like. At this time, a portion on the other end side of the anode lead and a portion on the other end side of the cathode lead extracted from the capacitor element are exposed from the mold. Alternatively, the solid electrolytic capacitor may be formed by placing the capacitor element in a bottomed case such that a portion of the other end side of the anode lead and a portion on the other end side of the cathode lead are positioned on the opening side of the bottomed case, and then sealing the opening of the bottomed case with a sealer.

The solid electrolytic capacitor may further include a case arranged on the outside of the resin exterior body as necessary. The resin material constituting the case may be a thermoplastic resin or a composition containing a thermoplastic resin. Examples of the metal material constituting the case include metals such as aluminum, copper, and iron, or alloys thereof (including stainless steel, brass, etc.).

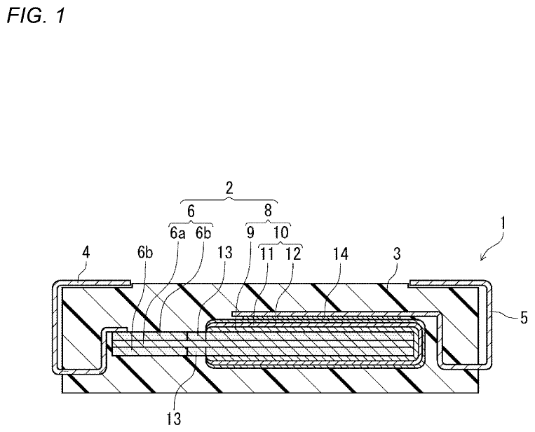

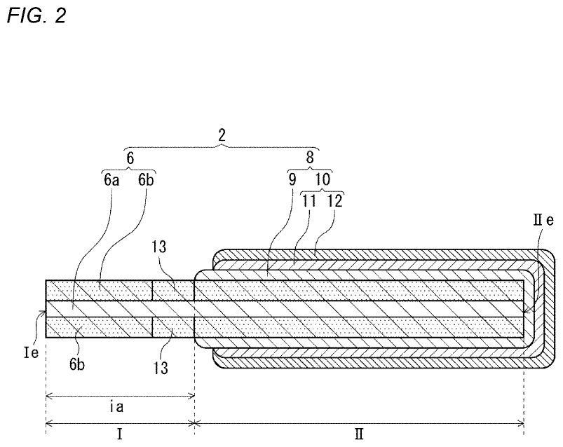

FIG. 1 is a cross-sectional view of a schematic structure of a solid electrolytic capacitor according to a first embodiment of the present disclosure, and FIG. 2 is an enlarged cross-sectional view of a schematic structure of a capacitor element 2 included in the solid electrolytic capacitor shown in FIG. 1.

The solid electrolytic capacitor 1 includes the capacitor element 2, an exterior body 3 that seals the capacitor element 2, and an anode lead terminal 4 and a cathode lead terminal 5 that are at least partially exposed to the outside of the exterior body 3. The exterior body 3 has a substantially rectangular parallelepiped outer shape, and the solid electrolytic capacitor 1 also has a substantially rectangular parallelepiped outer shape.

The capacitor element 2 includes an anode foil 6, a dielectric layer (not shown) that covers the surface of the anode foil 6, and a cathode part 8 that covers the dielectric layer. The dielectric layer need only be formed on at least a portion of the surface of the anode foil 6.

The cathode part 8 includes a solid electrolyte layer 9 and a cathode extraction layer 10. The solid electrolyte layer 9 is formed so as to cover at least a portion of the dielectric layer. The cathode extraction layer 10 is formed so as to cover at least a portion of the solid electrolyte layer 9. The cathode extraction layer 10 has a first layer 11 that is a carbon layer and a second layer 12 that is a metal paste layer. The cathode lead terminal 5 is electrically connected to the cathode part 8 via an adhesive layer 14 made of a conductive adhesive.

The anode foil 6 includes a base part (core part) 6a and porous parts 6b that are formed on the surface of the base part 6a. The anode foil 6 includes a second portion II, which is a cathode forming part where the solid electrolyte layer 9 (or the cathode part 8) is formed, and a first portion I that is other than the second portion II. The first portion I includes at least an anode part ia. The anode lead terminal 4 is electrically connected by welding to the anode part ia of the anode foil 6. The anode foil 6 has a first end Ie on the side connected to the anode lead terminal 4 and a second end IIe opposite the first end Ie.

Insulating regions 13 are provided between the first end Ie and the second end IIe of the anode foil 6. The insulating regions 13 may be provided at the end of the first portion I on the second portion II side. The insulating regions 13 include at least a cured product of the resin composition filling the pores of the porous parts 6b.

The exterior body 3 covers the capacitor element 2 and part of the lead terminals 4 and 5. From the viewpoint of inhibiting penetration of air into the exterior body 3, it is desirable that the capacitor element 2 and part of the lead terminals 4 and 5 are sealed by the exterior body 3. FIG. 1 shows the exterior body 3 that is a resin exterior body, but the present disclosure is not limited thereto. The exterior body 3 may be a case that is capable of housing the capacitor element 2, or the like. The resin exterior body is formed by sealing the capacitor element 2 and part of the lead terminals 4 and 5 with a resin material.

One end of each of the lead terminals 4 and 5 is electrically connected to the capacitor element 2, and the other end is extracted to the outside of the exterior body 3. In the solid electrolytic capacitor 1, the one end of each of the lead terminals 4 and 5 is covered by the exterior body 3 together with the capacitor element 2.

### EXAMPLES

The present invention will be specifically described below based on examples and comparative examples, but the present invention is not limited only to the following examples.

### Examples 1 and 2 and Comparative Example 1

### (1) Preparation of Anode Foil Having Dielectric Layer

An aluminum foil (thickness: 100 μm) was prepared as a base material, and both surfaces of the aluminum foil were etched to obtain an anode foil having porous parts at the surface layers (thickness: 35 μm on one main surface side of the aluminum foil, and thickness: m on the other main surface side).

The anode foil was immersed in a chemical conversion solution and a direct current voltage was applied to the anode foil, thereby forming a dielectric layer containing aluminum oxide on the surface of the anode foil.

### (2) Formation of Insulating Region

At a predetermined position between the first end and second end of the anode foil on which the dielectric layer was formed, both surfaces of the anode foil were impregnated with a treatment liquid containing a resin composition in a band shape along the entire width of the anode foil, and the treatment liquid was heated at 200° C. for 30 minutes to cure the resin composition. The resin composition cured in a state of filling the pores of the porous part. In this manner, an insulating region containing the cured product was formed. As the treatment liquid, a liquid composition containing a curable polyamideimide resin (precursor), γ-butyrolactone as a solvent, and a bisphenol A-type liquid epoxy resin (polymer) as a first additive was used. Table 1 shows the content rate (% by mass) of the dry solid content of the liquid composition, the content rate (% by mass) of the first additive in the resin composition (the dry solid content of the liquid composition), the viscosity (mPa·s) of the liquid composition at 25° C., and the Tg (° C.) of the cured product of the resin composition.

### (3) Formation of Solid Electrolyte Layer

The second portion of the anode foil having the insulating region obtained in step (2) on the second end side was immersed in a liquid composition containing a conductive material, and then taken out and dried to perform precoating. A power supply tape was attached to the surface of the insulating region.

A polymerization liquid (liquid composition) containing pyrrole (monomer of conjugated polymer), naphthalenesulfonic acid (dopant), and water was prepared. The precoated anode foil and a counter electrode were immersed in the obtained polymerization liquid. A voltage was applied to the power supply tape such that the potential of the power supply tape reached 2.0 V (=polymerization voltage), and electrolytic polymerization was performed at 25° C. to form a solid electrolyte layer. The polymerization voltage is the potential of the power supply body relative to a reference electrode (silver/silver chloride reference electrode).

### (4) Formation of Cathode Extraction Layer

The anode foil with the solid electrolyte layer obtained in step (3) was immersed in a dispersion liquid in which graphite particles were dispersed in water, and then taken out from the dispersion liquid and dried to form a carbon layer (first layer) at least on the surface of the solid electrolyte layer. The drying was performed at 150° C. for 30 minutes.

A silver paste containing silver particles and a binder resin (epoxy resin) was applied to the surface of the carbon layer, and the binder resin was cured by heating at 150° C. for 30 minutes to form a silver paste layer (second layer). In this manner, a cathode extraction layer constituted of the carbon layer and the silver paste layer was formed, and a cathode part constituted of the solid electrolyte layer and the cathode extraction layer was completed.

### (5) Assembly of Solid Electrolytic Capacitor

The cathode part of the capacitor element obtained in step (4) was joined to one end of the cathode lead terminal via an adhesive layer of a conductive adhesive. One end of the anode lead terminal was joined by laser welding to the surface of the first end side of the first portion of the anode foil that protrudes from the capacitor element.

Next, a resin exterior body of insulating resin was formed by molding around the capacitor element. At this time, the other end of the anode lead terminal and the other end of the cathode lead terminal were extracted from the resin exterior body. In this manner, a total of 20 solid electrolytic capacitors were completed.

### (6) Evaluation

The liquid composition containing the resin composition or the solid electrolytic capacitor was evaluated as described below.

(a) Viscosity of Treatment Liquid (Liquid Composition) and Solution with Concentration of 30% by Mass

The viscosity of the treatment liquid at 25° C. was measured by the procedure already described. In addition, the treatment liquid was diluted with y-butyrolactone such that the concentration of the resin composition in the treatment liquid was 30% by mass. The viscosity of the resulting solution at 25° C. was measured.

### (b) Tg of Cured Product of Resin Composition

A cured product of the resin composition was produced using the treatment liquid, and the Tg of the cured product was measured by the procedure already described.

### (c) Initial Electrostatic Capacitance, tan δ, and Equivalent Series Resistance (ESR)

In an environment at 20° C., the initial electrostatic capacitance (μF) and initial tan δ of each solid electrolytic capacitor at a frequency of 120 Hz were measured using an LCR meter for four-terminal measurement, and the initial ESR (mΩ) at a frequency of 100 kHz was also measured. Then, the average value of the 20 solid electrolytic capacitors was calculated. The result of each example is shown as a relative value to the result of Comparative Example 1 that is set to 100.

### (d) Leakage Current (LC)

A 1-kΩ resistor was connected in series to each solid electrolytic capacitor, and a rated voltage of 25 V was applied for one minute from a DC power source, after which leakage current (μA) was measured, and the average value of the 20 solid electrolytic capacitors was calculated. The result of each example is shown as a relative value to the result of Comparative Example 1 that is set to 100.

Table 1 shows the evaluation results. In Table 1, E1 and E2 denote Examples 1 and 2, and C1 denotes Comparative Example 1.

TABLE 1

| | Content rate | Content | Viscosity of | | | Electrostatic | | | Leakage |
|---|---|---|---|---|---|---|---|---|---|
| | of dry solid | rate of | treatment | Viscosity of | | capacity | tanδ | ESR | current |
| | content (% | additive (% | liquid | solution | Tg | (relative | (relative | (relative | (relative |
| | by mass) | by mass) | (mPa · s) | (mPa · s) | (° C.) | value) | value) | value) | value) |
| E1 | 30.0 | 13 | 3600 | 3600 | 256 | 102 | 28.6 | 58.4 | 0.338 |
| E2 | 45.5 | 50 | 22800 | 5800 | 250 | 97.8 | 25.0 | 51.5 | 0.291 |
| C1 | 31.6 | 0.1 | 86000 | 78000 | 285 | 100 | 100 | 100 | 100 |

As shown in Table 1, leakage current is significantly reduced in the examples compared to Comparative Example 1 in which the content rate of the first additive in the resin composition is 0.1% by mass. Polyimide resins such as polyamideimide resins have a high Tg and tend to increase the viscosity of the treatment liquid. When such a resin is diluted with a solvent, the dry solid content of the treatment liquid is reduced, making it difficult to fill the pores of the porous part at a high filling rate. Even if the first additive is added as in Comparative Example 1, when the content rate of the first additive is low, maintaining a certain content rate of dry solid content increases the viscosity of the treatment liquid, making it difficult to highly fill the pores of the porous part with the resin composition. In contrast, in the examples, the resin composition contains a larger amount of the first additive than that of Comparative Example 1. Accordingly, the viscosity of the treatment liquid containing the resin composition can be reduced while a relatively high dry solid content is maintained, despite the use of an insulating resin material that gives a high Tg, such as a polyimide resin. Thus, the pores of the porous part can be highly filled with the resin composition, which inhibits penetration of the liquid composition for precoating or the polymerization liquid for forming the solid electrolyte layer into the pores of the porous part in the insulating region or into the first portion through the pores. Therefore, in the examples, it is considered that the insulation of the insulating region was improved, and the insulation between the cathode part and the first portion was ensured, and thus leakage current was significantly reduced. Note that, in the examples, the filling rate of the cured product in the insulating region obtained by the above-described procedure is 80% or more.

In the examples, it is possible to significantly reduce the tan δ and ESR as compared to those in the comparative example while maintaining a high initial electrostatic capacitance equivalent to that of the comparative example. Thus, in the examples, it is possible to reduce leakage current as described above while maintaining excellent initial capacitor performance.

### Examples 3 to 6

In (2) of Example 1, the content rate (% by mass) of the dry solid content in the liquid composition and the viscosity of the liquid composition at 25° C. were adjusted such that the ratio t_{c}/t_{f} had the values shown in Table 2. Except for this, solid electrolytic capacitors were fabricated in the same manner as in Example 1.

Leakage current (LC) was evaluated by the procedure (d) described above. Out of the 20 solid electrolytic capacitors, the percentage (%) of the number of solid electrolytic capacitors in which leakage current exceeding 0.068 mA was measured was determined, and this percentage was set as an LC failure rate. In addition, out of the 20 solid electrolytic capacitors, the percentage (%) of the number of solid electrolytic capacitors in which leakage current exceeding 1 mA was measured was determined, and this percentage was set as a short circuit failure rate.

Table 2 shows the results. In Table 2, E3 to E6 denote Examples 3 to 6.

TABLE 2

| | E3 | E4 | E5 | E6 |
|---|---|---|---|---|
| t_{c}/t_{f} | 0.05 | 0.09 | 0.14 | 0.19 |
| Short circuit failure | 0.1 | 0.2 | 0.9 | 0.3 |
| rate (%) | | | | |
| LC failure rate (%) | 6.7 | 8.4 | 32.5 | 37.4 |

As shown in Table 2, from the viewpoint of ensuring a lower LC failure rate, the ratio t_{c}/t_{f} is preferably 0.12 or less, and more preferably 0.11 or less, or 0.10 or less. When the ratio t_{c}/t_{f} in such a range, the short failure rate can also be kept low.

Although the present invention has been described in terms of the presently preferred embodiments, it is to be understood that such disclosure is not to be interpreted as limiting. Various alterations and modifications will become apparent to those skilled in the art to which the present invention pertains, after having read the above disclosure. Accordingly, it is intended that the appended claims be interpreted as covering all alterations and modifications as fall within the true spirit and scope of the invention.

In the solid electrolytic capacitor of the present disclosure, leakage current is reduced and excellent capacitor performance can be obtained. Thus, the solid electrolytic capacitor can be used in various use applications requiring high reliability, for example.

### REFERENCE NUMERALS

1: Solid electrolytic capacitor
2: Capacitor element
3: Exterior body
4: Anode lead terminal
5: Cathode lead terminal
6: Anode foil
6a: Base part (core part)
6b: Porous part
8: Cathode part
9: Solid electrolyte layer
10: Cathode extraction layer
11: Carbon layer (first layer)
12: Silver paste layer (second layer)
13: Insulating region
14: Adhesive layer
I: First part
II: Second part
Ie: First end
IIe: Second end
ia: Anode part

What is claimed is:

1. A solid electrolytic capacitor element comprising:
an anode foil having a porous part at a surface layer, and having a first portion including a first end and a second portion including a second end opposite the first end;
a dielectric layer formed on a surface of the porous part; and
a solid electrolyte layer covering at least a portion of the dielectric layer,
wherein the solid electrolytic capacitor element has, between the first end and second end of the anode foil, an insulating region containing a cured product of a resin composition,
in the insulating region, pores of the porous part are filled with the cured product,
the resin composition contains an insulating resin material and an additive that modifies the insulating resin material,
a content rate of the additive in the resin composition is 3% by mass or more, and
a glass transition point of the cured product is 230° C. or more.

2. The solid electrolytic capacitor element according to claim 1, wherein in the resin composition, a viscosity at 25° C. of a 7-butyrolactone solution containing the resin composition at a concentration of 30% by mass is 1,000 mPa·s or more and 10,000 mPa·s or less.

3. The solid electrolytic capacitor element according to claim 1, wherein the content rate of the additive in the resin composition is 60% by mass or less.

4. The solid electrolytic capacitor element according to claim 1, wherein the additive interacts or reacts with the insulating resin material.

5. The solid electrolytic capacitor element according to claim 1, wherein the additive contains a polymer of an epoxy compound.

6. The solid electrolytic capacitor element according to claim 1, wherein the insulating resin material includes a polyimide resin.

7. The solid electrolytic capacitor element according to claim 1, wherein in a cross section of the solid electrolytic capacitor element in the insulating region, a proportion of an area of the cured product filling the pores to a total area of the pores is 80% or more.

8. The solid electrolytic capacitor element according to claim 1,
wherein in the insulating region, the cured product is further formed on a main surface of the anode foil via the dielectric layer,
on the main surface of the anode foil, the cured product formed on the dielectric layer on one main surface side of the anode foil has a maximum thickness of t_{c}, and the anode foil has a thickness of t_{f}, and
a ratio of the maximum thickness t, of the cured product to the thickness t_{f} of the anode foil (=t_{c}/t_{f}) is 0.12 or less.

9. A solid electrolytic capacitor comprising at least one of the solid electrolytic capacitor element according to claim 1.

10. The solid electrolytic capacitor according to claim 9, further comprising an exterior body that seals the solid electrolytic capacitor element.

11. A manufacturing method of a solid electrolytic capacitor element, comprising:
a first step of preparing an anode foil having a porous part at a surface layer, and having a first portion including a first end and a second portion including a second end opposite the first end;
a second step of forming a dielectric layer on a surface of the porous part;
a third step of forming, between the first end and second end of the anode foil, an insulating region containing a cured product of a resin composition; and
a fourth step of forming a solid electrolyte layer covering at least a portion of the dielectric layer,
wherein the resin composition contains an insulating resin material and an additive that modifies the insulating resin material, a content rate of the additive in the resin composition is 3% by mass or more, and a glass transition point of the cured product is 230° C. or more, and
the third step includes a sub-step of filling the pores of the porous part with a treatment liquid containing the resin composition and a solvent, and curing the resin composition.

12. The manufacturing method of a solid electrolytic capacitor element according to claim 11, wherein a content rate of a dry solid content in the treatment liquid is 30% by mass or more, and a viscosity of the treatment liquid at 25° C. is 1,000 mPa·s or more and 50,000 mPa·s or less.

13. The manufacturing method of a solid electrolytic capacitor element according to claim 11, wherein the fourth step includes a second sub-step of forming at least a portion of the solid electrolyte layer by in situ polymerization of a precursor of a conjugated polymer in the presence of a dopant.

14. The manufacturing method of a solid electrolytic capacitor element according to claim 13, wherein the fourth step includes a first sub-step of precoating a surface of the dielectric layer with a liquid composition containing a conductive material, prior to the second sub-step.
